(19) United States
(12) Patent Application Publication
(10) Pub. No.: US 2001/0005070 A1
(43) Pub. Date: Jun. 28, 2001

(54) Furniture transport truck

(76) Inventor: Ronald B. Kemnitzer, Olathe, KS (US)

Correspondence Address: James E. Brunton, Suite 860, 700 North Brand Blvd., P.O. Box 29000, Glendale, CA, 91029, US

(21) Appl. No.: 09/767,235

(22) Filed: Jan. 18, 2001

Related U.S. Application Data
(62) Division of application No. 09/372,393, filed on Aug. 10, 1999.

(51) Int. Cl. B62B 3/00; B62D 39/00

(52) U.S. Cl. 280/33.991; 280/79.2; 280/47.26

(57) ABSTRACT

A transport truck that can be used to safely move various articles of furniture, including heavy stacks of differently configured chairs from one location to another. The transport truck includes specially configured article support members and assemblies that can be affixed to the base of the transport truck to safely transport various kinds of furniture from auditoriums, conference rooms and like to storage areas.

### BACKGROUND OF THE INVENTION

This is a Divisional application of co-pending application U. S. application Ser. No. 09/372,393 filed Aug. 10, 1999.

### FIELD OF THE INVENTION

The present invention relates generally to transport vehicles for transporting furniture. More particularly the invention concerns a wheeled truck having a novel supporting structure that is connected to the base of the truck. Alternate forms of supporting structures are provided so that a particular supporting structure can be selected and affixed to the base to transport table tops, chairs of various configurations and like articles.

### DISCUSSION OF THE PRIOR ART

Wheeled transport carts or trucks are old in the art and a wide variety of carts of various designs have been suggested in the past. Typically these transport carts comprise a flat platform to which a plurality of wheels or castors are rotatably connected. A handle of some type is connected to the platform to enable the cart to be pulled or pushed from place to place. While the prior art wheeled transport trucks are well-suited for carrying regularly shaped articles such as boxes, drums and like bulky articles, they are not well suited for transporting irregularly shaped articles such as chairs.

The extensive use of removable tables and chairs in a variety of public gathering places has presented a problem, namely how-to quickly and efficiently transfer the tables and chairs from auditoriums, meeting halls, large conference rooms and the like to remote storage areas. Attempts have been made in the past to use the prior art flat platform transport trucks for this purpose, but these trucks are not well suited because chairs and like irregularly shaped articles have a tendency to slide off the flat platform. Modifications to the prior art wheeled trucks are, therefore, needed to accomplish the transport of articles of furniture, such as chairs of various configurations. The thrust of the present invention is to provide such modifications to thereby provide a wheeled transport truck that is ideally suited for the safe transport of a variety of differently configured types of furniture.

The prior art chairs have taken on the number of different configurations, including conventional tubular frame chairs having four, ground-engaging legs and folding chairs of various designs. Special provisions must be made to safely and efficiently transport these types of chairs as well as folding chairs of various configurations. One of the objectives of the present invention is to provide a wheeled truck having a number of different types of carrying attachments for safely transporting chairs of various configurations, including conventional chairs as well as folding chairs.

As will be better understood from the discussion that follows, the unique design of the transport trucks of the present invention permits the safe and easy transport of differently configured tables and chairs from the auditorium or other place of use to the storage area. More particularly, one form of the novel transport cart of the invention comprises a base assembly to which variously configured support assemblies can be affixed. The variously configured support assemblies are specially designed to safely support table tops as well as chairs having conventional ground engaging legs and folding chairs of various designs.

### SUMMARY OF THE INVENTION

It is an object of the present invention to provide an easy to use transport truck that can be safely used to move table tops, differently configured chairs in stacked arrays and other articles from one location to another.

It is another object of the invention to provide a transport truck of the character described which includes specially configured chair support track assemblies that are affixed to the base of the transport truck and can be readily interchanged as required.

Another object of the invention is to a provide transport truck of the character described in the preceding paragraphs which, by selecting one of several differently configured support assemblies, enables a truck of relatively standard design to be used to safely transport differently configured chairs.

Another object of the invention is to provide the transport truck for use in transporting table tops, chairs and like articles which is highly versatile, is of a sturdy, compact and light weight configuration and can be safely operated by a single workman.

Another object of the invention is to provide a transport truck of the class described that is durable, rugged in use, requires minimum maintenance and can be relatively inexpensively manufactured.

### BRIEF DESCRIPTION OF THE DRAWINGS

FIG. 1 is a generally perspective view of one form of the chair transport truck of the present invention for carrying table tops of a first width.

FIG. 2 is a generally perspective of view of the chair transport truck shown in FIG. 1 with the table tops removed.

FIG. 3 is a side elevational view of the transport truck shown in FIG. 2.

FIG. 4 is a bottom plan view of the transport truck shown in FIG. 2.

FIG. 5 is an end view of the transport truck shown in FIG. 2.

FIG. 6 is a generally perspective view of an alternative form of the transport truck of the present invention for carrying table tops of a second width.

FIG. 7 is a generally perspective of view of the chair transport truck shown in FIG. 6 with the table tops removed.

FIG. 8 is a side elevational view of the transport truck shown in FIG. 7.

FIG. 9 is a bottom plan view of the transport truck shown in figure 7.

FIG. 10 is an end view of the transport truck shown in FIG. 7.

FIG. 11 is a generally perspective view of still another form of the transport truck of the present invention for carrying chairs of a conventional non-foldable configuration.

FIG. 12 is a side elevational view of the transport truck shown in FIG. 11.

FIG. 13 is a bottom plan view of the transport truck shown in FIG. 11.

FIG. 14 is an end view of the transport truck shown in FIG. 11.

FIG. 15 is a generally perspective view of yet another form of the transport truck of the present invention for carrying folding chairs.

FIG. 16 is a top plan view of the transport truck shown in FIG. 15.

FIG. 17 is bottom plan view of the transport truck shown in FIG. 15.

FIG. 18 is a side elevational view of the transport truck shown in FIG. 15.

FIG. 19 is an end view of the transport truck shown in FIG. 15.

### DESCRIPTION OF THE INVENTION

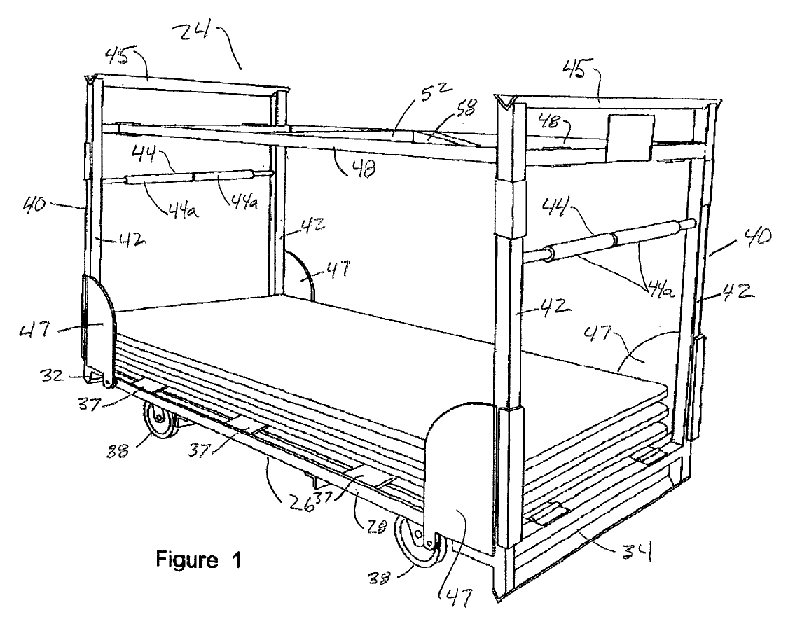

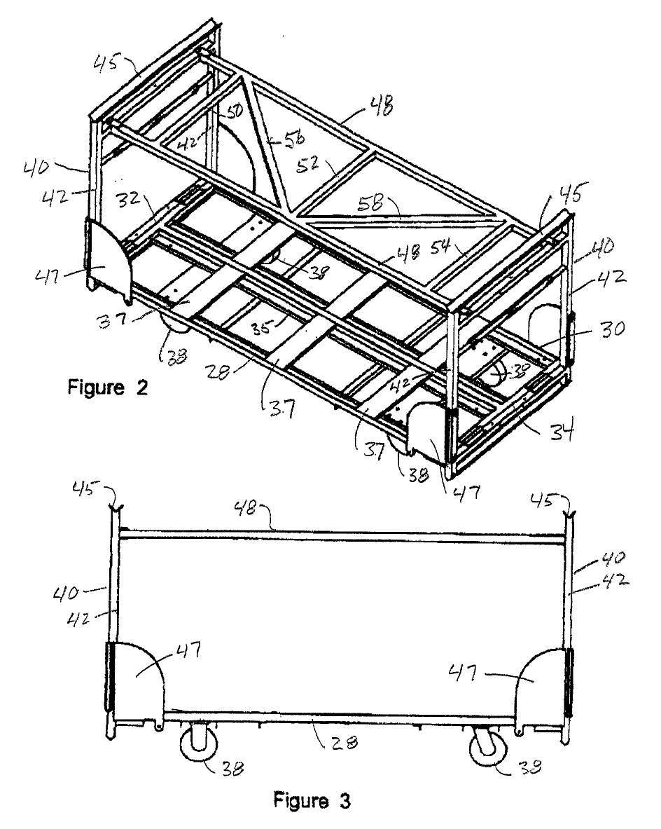

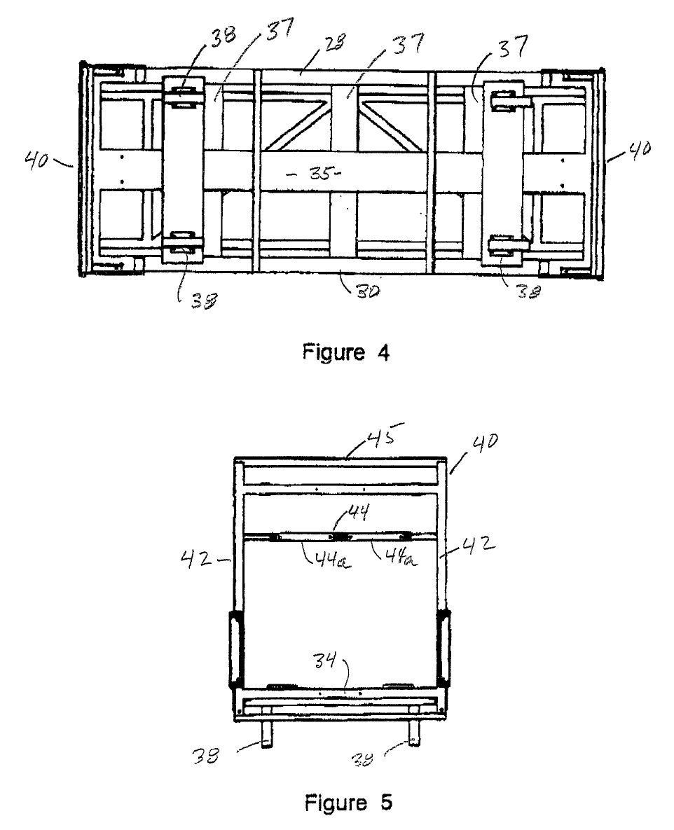

Referring to the drawings and particularly to FIGS. 1 through 5, one form of the transport truck of the present invention is there illustrated and generally designated by the numeral 24. Transport truck 24 is specially designed for transporting table tops of differing configurations which are disposed in a stacked relationship in a manner shown in FIG. 1. In this first embodiment of the invention, the transport truck comprises a base assembly 26 having transversely spaced-apart sides 28 and 30 and longitudinally spaced-apart ends 32 and 34 connected to and spanning sides 28 and 30. As best seen by referring to FIG. 2, base assembly 26 includes a longitudinally extending central support 35 and a plurality of spaced apart article support members 37. Ground engaging roller means, shown here as a plurality of ground engaging wheels 38, are connected to base assembly 26 in the manner shown in FIG. 4.

Provided at either end of the base assembly 26 is a generally vertically extending end support assembly 40. Each end support assembly 40 comprises a pair of generally vertically extending support members 42 which are connected proximate their lower ends to base assembly 26. To push or pull the transport truck along the ground, a push bar or handle assembly 44 is affixed to and spans support members 42 in the manner best seen in FIG. 1. Each handle assembly 44 includes a pair of generally cylindrically shaped hand grip portions 44a. Also forming a part of each end support assembly 40 is a transversely extending top member 45. Provided at each corner of the transport truck is a curved plate like article retaining member 47.

Connected to and spanning support assemblies 40 is a top assembly 46. Top assembly 46 includes a pair of transversely spaced apart, longitudinally extending beams 48. Connected to and spanning beams 48 are three cross members 50, 52 and 54. An angularly extending cross the brace 56 extends between cross members 52 and 54 and an angularly extending support brace 58 extends between cross members 52 and 54 so as to form a generally planar top support of the configuration best seen in FIG. 2.

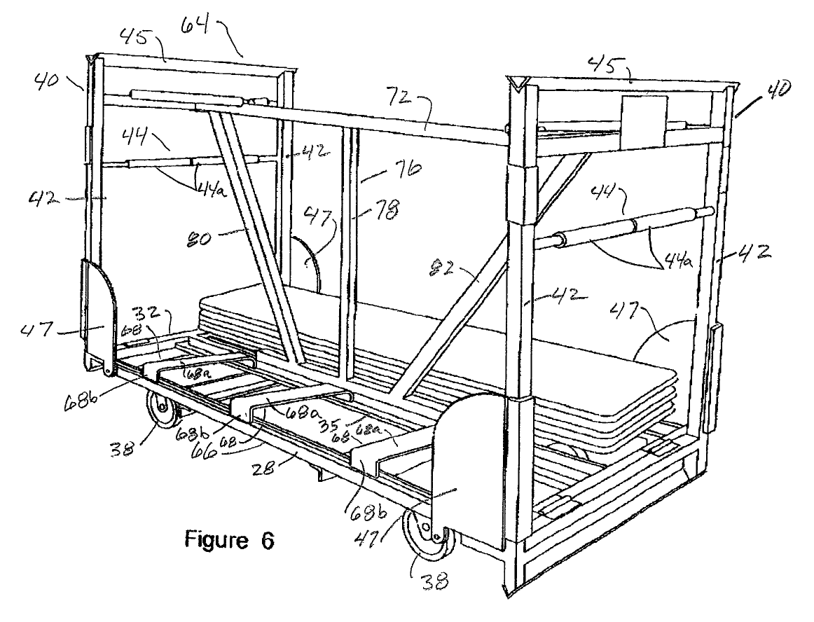

Referring next to FIGS. 6 through 10, an alternate form of the transport truck of the present invention is there illustrated and generally designated by the numeral 64. Transport truck 64 is similar in construction to that shown in FIGS. 1 through 5 and like numerals are used to identify like components in FIGS. 6 through 10. Transport truck 64 is specially designed for transporting table tops of a lesser width than those shown in FIG. 1.

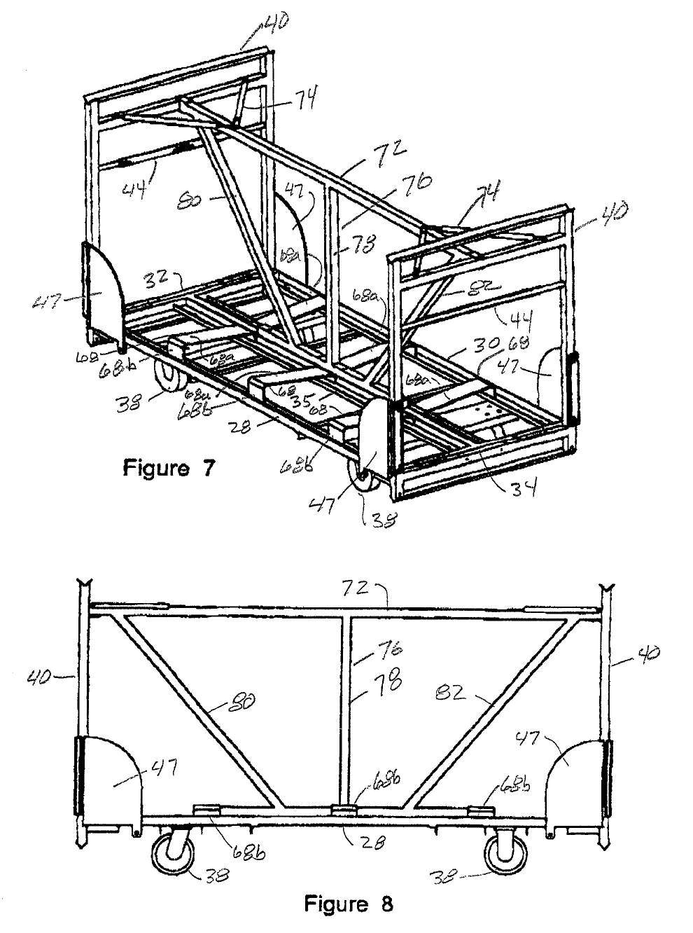

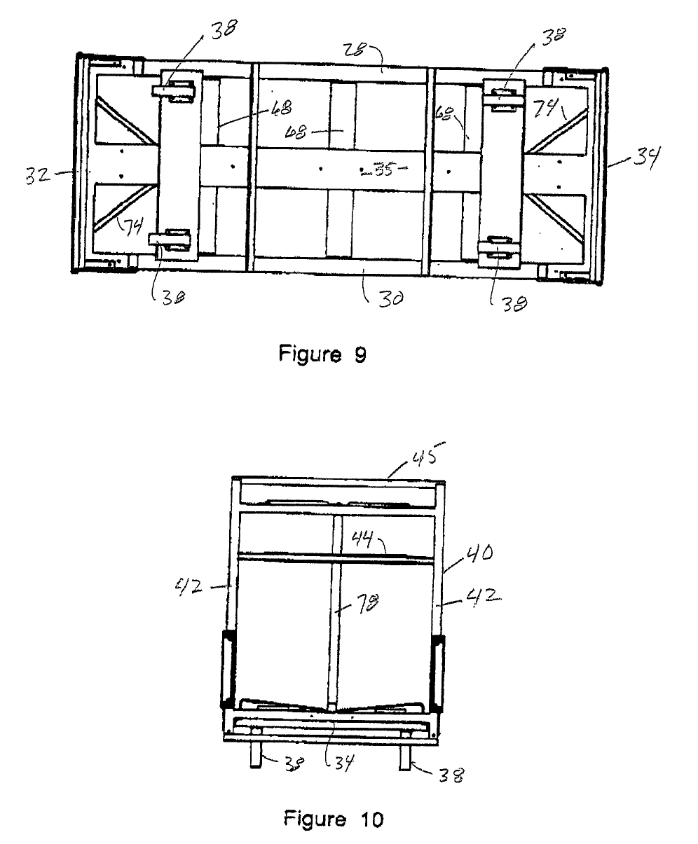

In this second embodiment of the invention, the transport truck comprises a base assembly 66, which is similar construction to base assembly 26 and includes transversely spaced-apart sides 28 and 30 and longitudinally spaced-apart ends 32 and 34 connected to and spanning sides 28 and 30. As best seen by referring to FIG. 7, base assembly 66 also includes a longitudinally extending central support 35 and a plurality of spaced apart article support members. However, these article support members, which are generally identified by the numeral 68, extend angularly downward from the sides of the base assembly toward central support 35. More specifically, each article support member or 68 includes a downwardly sloping central portion 68a and a generally vertically extending leg portion 68b which interconnects central portion 68a with a selected one of the side members 28 and 30. With this construction, when the more narrow table tops are disposed in a stacked relationship on the base assembly in the manner shown in FIG. 6 they tend to safely slope inwardly toward a central divider the character of which will put presently be described. Ground engaging wheels 38 are connected to base assembly 66 in the manner shown in FIG. 9.

Provided at either end of the base assembly 66 is a generally vertically extending end support assembly 40. Each end support assembly 40 comprises a pair of generally vertically extending support members 42 which are connected proximate their lower ends to base assembly 66. To push or pull the transport truck along the ground, a push bar or handle assembly 44 is affixed to and spans support members 42 in the manner best seen in FIG. 6. As before, each handle assembly 44 includes a pair of generally cylindrically shaped hand grip portions 44a. Also forming a part of each end support assembly 40 is a transversely extending top member 45. As in the earlier described embodiment of the invention, the transport truck is provided proximate each corner with a curved article retaining member 47.

Connected to and spanning support assemblies 40 is a top assembly 70. Top assembly 70 includes a single longitudinally extending beam 72 and a pair of angularly extending braces 74 disposed proximate either end of beam 72. Depending downwardly from beam 72 is the previously mentioned central divider assembly 76 which includes a central, generally vertically extending support 78 and a pair angularly extending support braces 80 and 82.(see FIG. 8).

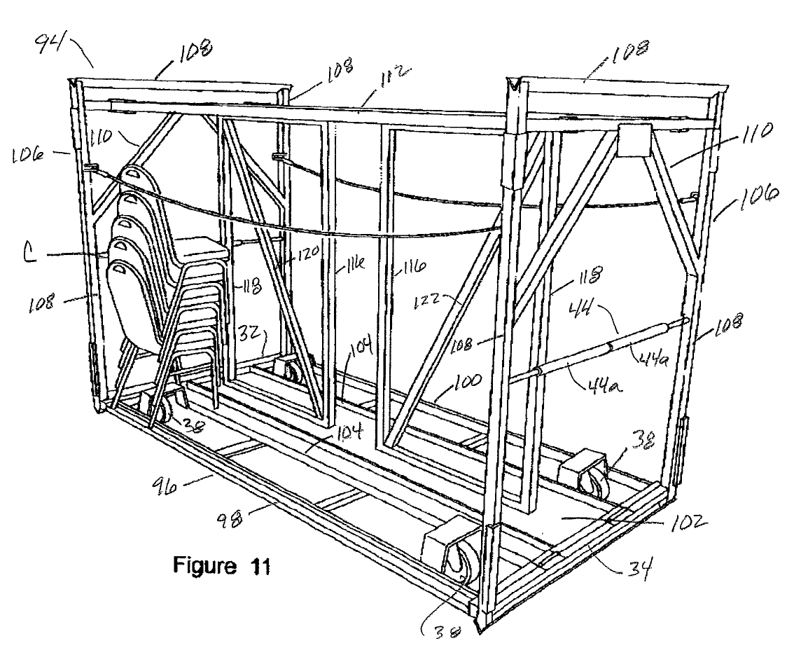

Referring next to FIGS. 11 through 14, still another form of the transport truck of the present invention is there illustrated and generally designated by the numeral 94. Transport truck 94 is also similar and construction to that shown in FIGS. 1 through 5 and like numerals are used to identify like components in FIGS. 11 through 14. Transport truck 94 is specially designed for transporting conventional chairs of the character shown in FIG. 11, that is non-folding chairs having four spaced apart, ground engaging legs.

In this third embodiment of the invention, the transport truck comprises a base assembly 96, which is similar construction to base assembly 26 and includes transversely spaced-apart sides 98 and 100 and longitudinally spaced-apart ends 32 and 34 connected to and spanning sides 98 and 100. As best seen by referring to FIG. 11, base assembly 96 also includes a longitudinally extending central support 102 and a plurality of spaced apart article support members. However, these article support members, which are generally identified by the numeral 104, extend longitudinally of the base assembly and are generally parallel to central support 102. These uniquely configured article support members comprise a part of the first and second chair support assemblies of the apparatus of this latest of form of the present invention which span and are connected to longitudinally spaced apart ends 32 and 34. More specifically, each article support member 102 of the first and second chair support assemblies here comprises a supporting track which is constructed and arranged to receive a pair of the ground engaging legs of a conventional chair with an. In this latest form of the invention side members 98 and 100 are generally channel and the shaped and are adapted to receive a pair of the ground engaging legs of the lowest most chair of the array of stacked chairs “C”. Support members 102, as well as side members 98 and 100 are generally channel shaped so as to limit transverse movement of the stack of chairs relative to the base. Ground engaging wheels 38 are connected to base assembly 66 in the manner shown in FIG. 11.

Provided at either end of the base assembly 96 is a generally vertically extending end support assembly 106. Each end support assembly 106 is of similar construction to end support assemblies 40 and comprises a pair of generally vertically extending support members 108 which are connected proximate their lower ends to base assembly 66. To push or pull the transport truck along the ground, a push bar or handle assembly 44 is affixed to and spans support members 108 in the manner best seen in FIG. 11. As before, each handle assembly 44 includes a pair of generally cylindrically shaped hand grip portions 44a. Also forming a part of each end support assembly 106 is a transversely extending top member 108. Unlike end support assemblies 40 each end support assembly 106 includes a pair of angularly extending support braces 110. As in the earlier described embodiments of the invention, the transport truck is provided proximate each corner with a curved article retaining member 47.

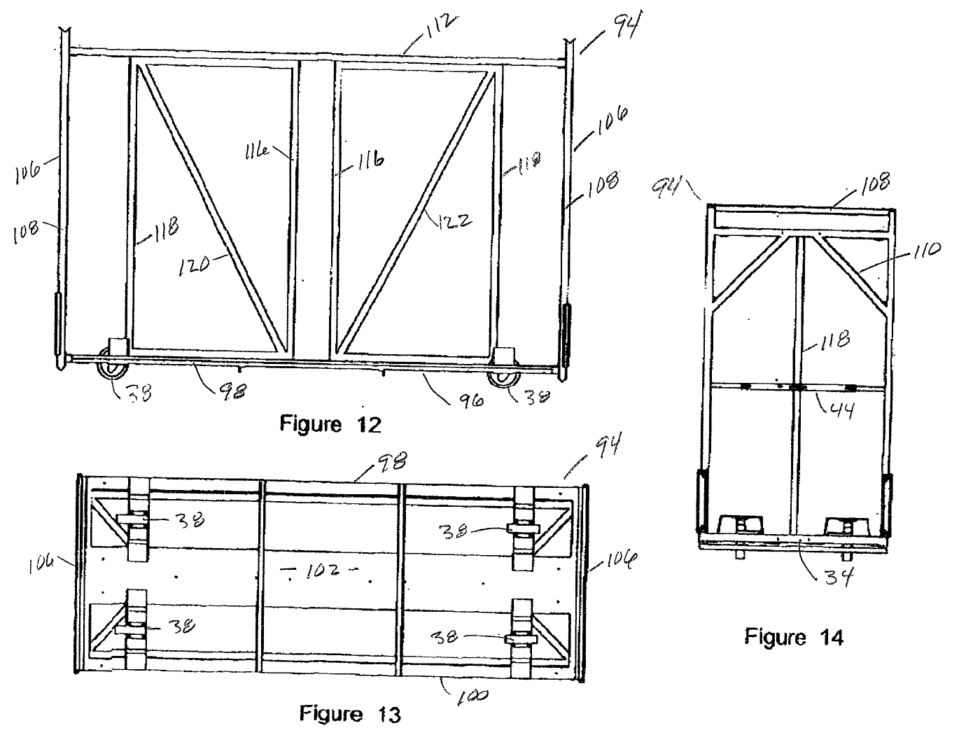

Connected to and spanning support assemblies 106 is a longitudinally extending beam 112. Depending downwardly from beam 112 is a central divider assembly 114 which includes a pair of centrally disposed, generally vertically extending supports 116 and a pair of spaced apart, a generally vertically extending supports 118. An angularly extending support brace 120 interconnects one pair to supports 116 and a 118 and second angularly extending support brace 122 interconnects the other pair of supports 116 and 118. (see FIG. 12). In the manner best seen in FIG. 11, the first support assembly that supports the array of stacked chairs “C” is disposed on one side of central divider assembly 114 and in the second chair support assembly is disposed on the opposite side of central divider assembly 114. More specifically, the first support assembly comprises side member 98 and a one of the track members 104, while the second support assembly comprises side member 100 and in the other of the track members 104.

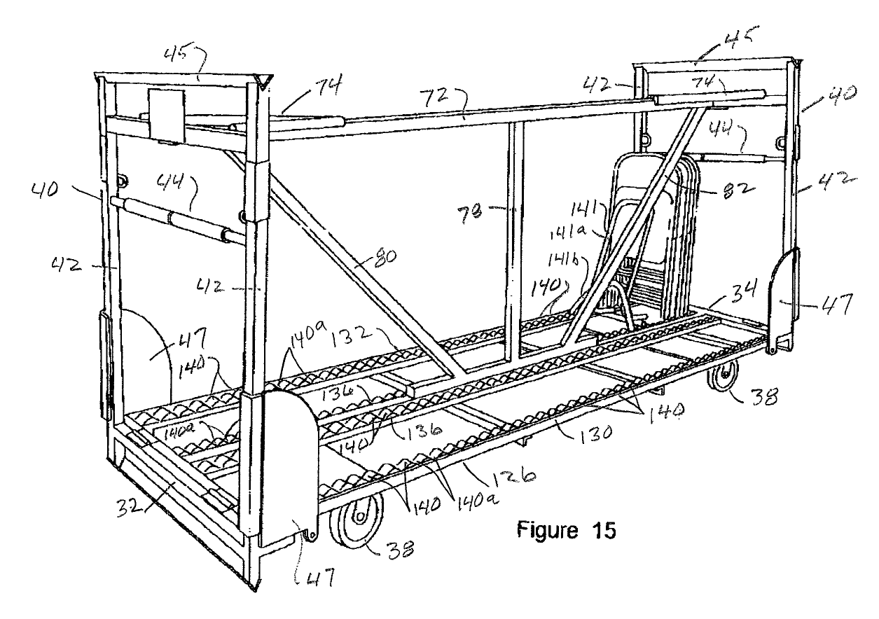

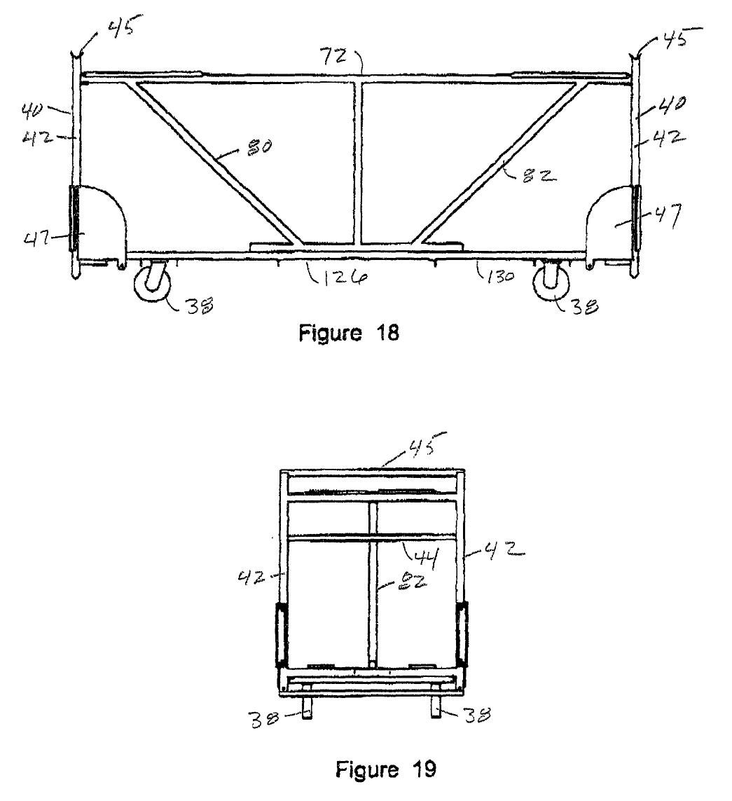

Turning now to FIGS. 15 through 19, still another form of the transport truck of the present invention is there illustrated and generally designated by the numeral 124. Transport truck 124 is also similar in construction to that shown in FIGS. 11 through 14 and like numerals are used to identify like components in FIGS. 15 through 19. Transport truck 124 is specially designed for transporting folding chairs in a folded configuration in the manner shown and FIG. 15.

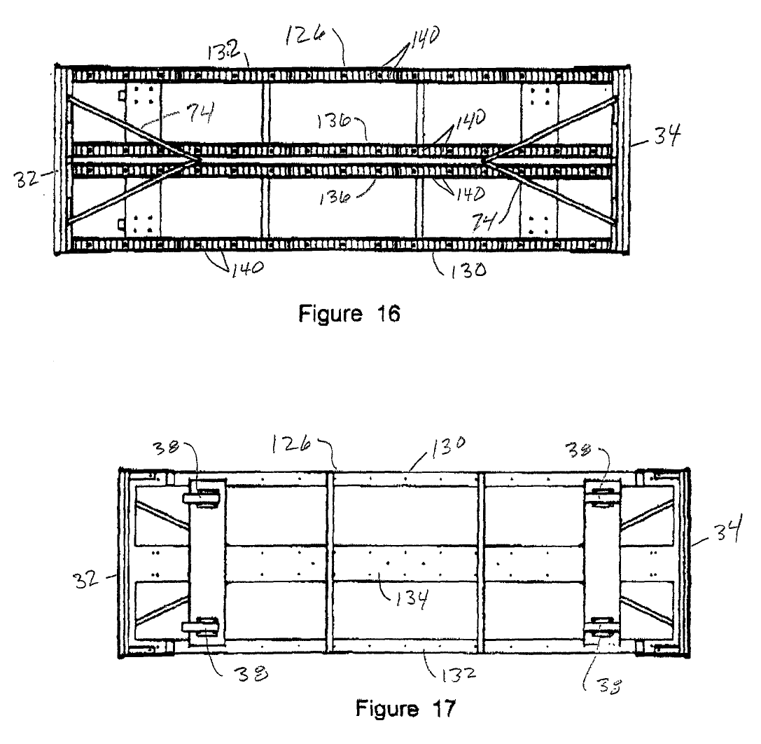

In this fourth embodiment of the invention, the transport truck comprises a base assembly 126, which is similar construction to base assembly 96 and includes transversely spaced-apart sides 130 and 132 and longitudinally spaced-apart ends 32 and 34 connected to and spanning sides 130 and 132. As best seen by referring to FIG. 16, base assembly 126 also includes a longitudinally extending central support 134 and a plurality of spaced apart article support members. These article support members, which are generally identified by the numeral 136, extend longitudinally of the base assembly and are generally parallel to central support 134. As in the previously described embodiment of the invention, each article support member 136 comprises a supporting track which is constructed and arranged to receive a pair of the ground engaging legs of the chairs to be transported on the transport track. In this latest form of the invention side members 130 and 132 are also track shaped and are adapted to receive the ground engaging legs of the folding chairs positioned along the track in the manner shown and FIG. 15. Support members 136 as well as side members 130 and 132 are uniquely shaped so as to limit longitudinal movement of the chairs. More particular, as best seen in FIGS. 15 and 16, each of the legs supporting tracks, as well as side members 98 and 100, provided with a plurality of longitudinally spaced apart protuberances 140. The valleys 140a which are disposed between each of the protuberances 140 receive the legs of the folded chairs and restrain them from moving longitudinally along the tracks. To maintain a particular group of folding chairs in the correct orientation along the tracks, a frame like assembly 141 is provided. Frame assembly 141 includes an upper frame portion 141a, which engages the group of folding chairs and a curved, track engaging portion 141b the legs of which are receivable within the valleys 140a formed between protuberances 140.(FIG. 15). As before, ground engaging wheels 38 are connected to base assembly 126 in the manner shown in FIG. 17.

Provided at either end of the base assembly 126 is a generally vertically extending end support assembly 40. Each end support assembly 40 comprises a pair of generally vertically extending support members 42 which are connected proximate their lower ends to base assembly 126. To push or pull the transport truck along the ground, a push bar or handle assembly 44 is affixed to and spans support members 108 in the manner best seen in FIG. 11. Also forming a part of each end support assembly 40 is a transversely extending top member 45. As in the earlier described embodiments of the invention, the transport truck is provided proximate each corner with a curved article retaining member 47.

Connected to and spanning support assemblies 40 is a longitudinally extending beam 72. Depending downwardly from beam 72 is a central divider assembly 76 which is substantially identical to central divider 76 shown in FIG. 6, and includes a generally vertical support 78 and a pair of angularly extending support braces 80 and 82. As was the case in the previously described embodiment of the invention, the first chair support assembly of the apparatus is disposed on one side of central divider assembly 76 and the other, or second chair support assembly is disposed on the opposite side of central divider assembly 76. In this latest form of the invention the first chair support assembly comprises side member 126 and a one of the support members 136, while the second chair support assembly comprises side member 132 and the other of the support members 136.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A transport truck for transporting articles of furniture, comprising:
(a) a base assembly comprising:
(i) transversely spaced apart sides;
(ii) longitudinally spaced-apart ends connected to said sides;
(iii) a pair of generally vertically extending support assemblies connected to each of said the longitudinally spaced apart ends; and
(iv) at least one longitudinally extending beam connected to and spanning said generally vertically extending support assemblies;
(b) a wheel assembly connected to said base assembly; and
(c) a plurality of specially configured, spaced apart support members connected to said base assembly for supporting the articles of furniture to be transported.

2. The transport truck as defined in claim 1 in which each of said spaced apart support members, comprises an inwardly sloping central portion for engagement with the articles of furniture and an end portion connected to said central portion and to said side members of said base assembly.

3. The transport truck as defined in claimed 1, further including a central divider assembly extending between said the end support assemblies.

4. The transport truck as defined in claim 1 in which the transport truck is adapted for the transport of chairs and in which each of said the spaced apart support members comprises a longitudinally extending track for engagement with a pair of ground engaging legs of a chair.

5. The transport truck as defined in claim 4 in which said longitudinally extending track is generally channel shaped.

6. The transport track as defined in claim 4 in which said longitudinally extending track is provided with a plurality of spaced apart protuberances defining therebetween valleys for the engagement by the legs of a folding chair.

7. A chair transport truck for transporting chairs comprising:
(a) a base assembly comprising:
(i) transversely spaced apart sides;
(ii) longitudinally spaced-apart ends connected to said sides;
(iii) a pair of generally vertically extending support assemblies connected to each of said the longitudinally spaced apart ends; and
(iv) at least one longitudinally extending beam connected to and spanning said generally vertically extending support assemblies;
(b) a wheel assembly connected to said base assembly;
(c) a first chair support assembly connected to and the spanning said the longitudinally spaced apart ends for supporting chairs of a first configuration, said first chair support assembly comprising a pair of transversely spaced apart chair leg supporting tracks.

8. The chair transport truck as defined in claim 7 further comprising a second chair support assembly connected to and the spanning said the longitudinally spaced apart ends for supporting chairs of a first configuration, said second chair support assembly comprising a pair of transversely spaced apart chair leg supporting tracks.

9. The chair transport truck as defined in claim 8 in which said transversely spaced apart chair leg supporting tracks are generally channel shaped.

10. The chair transport truck as defined in claim 8 in which said transversely spaced apart chair leg supporting tracks each include a plurality of longitudinally spaced apart protuberances.

11. The chair transport truck as defined in claim 8, in which at least one of said pair of vertically extending support assemblies includes a push bar for use in pushing said transport truck.

12. The chair transport truck as defined in claim 8 further including a centrally disposed divider assembly connected to said longitudinally extending beam.
